(19) United States
(12) Patent Application Publication
(10) Pub. No.: US 2024/0289594 A1
(43) Pub. Date: Aug. 29, 2024

(54) EFFICIENT HIDDEN MARKOV MODEL ARCHITECTURE AND INFERENCE RESPONSE

(71) Applicant: QUALCOMM Incorporated, San Diego, CA (US)

(72) Inventors: Mustafa KESKIN, San Diego, CA (US); Fatih Murat PORIKLI, San Diego, CA (US)

(21) Appl. No.: 18/175,750

(22) Filed: Feb. 28, 2023

(51) Int. Cl. G06N 3/047; G06N 3/044; G06N 3/045; G06N 3/0985

(52) U.S. Cl. CPC G06N 3/047; G06N 3/044; G06N 3/045; G06N 3/0985

(57) ABSTRACT

Certain aspects of the present disclosure provide techniques and apparatus for improved hidden Markov model (HMM)-based machine learning. A sequence of observations is accessed. A hidden Markov model (HMM) comprising a set of transition probabilities, a set of emission probabilities, a transition coefficient hyperparameter, and an emission coefficient hyperparameter is also accessed, and a first output inference from the HMM is generated based on the sequence of observations.

Aspects of the present disclosure relate to machine learning.

Various machine learning architectures have been used to provide solutions for a wide variety of computational problems. For example, some systems use Hidden Markov Models (HMMs) to analyze temporal and/or sequential data, such as to provide voice wakeup functionality, speech recognition, natural language processing, video activity detection, optical character recognition, and the like. HMMs have also been used in part of speech recognition, recognizing the next word or a particular sequence of phrases, and the like.

One notable advantage of HMMs is the computationally fast response/inference that can be achieved, as compared to other solutions such as large neural networks (e.g., with a large number of parameters), using techniques such as the dynamic Viterbi algorithm. However, there remains a desire for improved prediction accuracy and inference efficiency for such architectures.

### BRIEF SUMMARY

Certain aspects provide a method comprising: accessing a sequence of observations; accessing a hidden Markov model (HMM) comprising a set of transition probabilities, a set of emission probabilities, a transition coefficient hyperparameter, and an emission coefficient hyperparameter; and generating a first output inference from the HMM based on the sequence of observations.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 depicts an example workflow for improved machine learning using hyperparameters.

FIG. 2 depicts an example modified machine learning architecture with an embedded machine learning model.

FIG. 3 depicts an example modified machine learning architecture with an appended machine learning model.

FIG. 4 depicts an example modified machine learning architecture with dynamic hyperparameters using a machine learning model.

FIG. 5 depicts an example multi-branch machine learning architecture with a fusion machine learning model.

FIG. 6 is a flow diagram depicting an example method for improved machine learning.

FIG. 7 is a flow diagram depicting an example method for generating output inferences using improved HMM-based models.

FIG. 8 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for improved hidden Markov model (HMM)-based models using modified hyperparameters and architectures.

In some aspects, HMM-based architectures can be used to provide effective evaluation of a wide variety of sequential data (e.g., a sequence of observations or inputs). For example, without limitation, aspects of the present disclosure may be used to provide improved voice detection and/or device-wakeup based on speech analysis, speech recognition, natural language processing, video analysis or classification (e.g., for activity detection), optical character recognition, part of speech detection, action or gesture recognition, various audio processing solutions, sentence generation, various computational biology solutions, path-finding solutions (e.g., for robotics), prediction of protein structures, sequence structure tracking for borders between air and ice and/or ice and rock, and the like. Generally, aspects of the present disclosure are readily applicable to any tasks involving a sequence of observed elements.

In some aspects, the Viterbi algorithm is used to provide more efficient inferencing using modified HMM architectures. The Viterbi algorithm is a dynamic programming algorithm that enables efficient determination of the maximum a posteriori probability estimate from a most likely sequence of hidden states that results in a sequence of observed events. Generally, during inference and/or during the forward pass of training, previously calculated values can be used to reduce the computational expense of determining the transition to the next state in the sequence. In some aspects, during training, the model uses training data (e.g., a sequence of observations) to learn various parameters such as emission probabilities and state transition probabilities. For example, the model may learn transition probabilities in the form of pᵢⱼ=P(Qₜ₊₁=j|Qₜ=i), where pᵢⱼ is the probability of transitioning from state i to state j, (e.g., the probability that the next state Qₜ₊₁ is state j, given that the current state Qₜ is state i). As another example, the model may learn emission probabilities in the form of eᵢ(a)=P(Oₜ=α|Qₜ=i), where eᵢ(α) is the probability of emission a being output at the current time Oₜ (e.g., the probability that the emitted output is a given that the current state Qₜ is state i). As yet another example, the model may learn an initial state distribution in the form of wᵢ=P(Q₀=i) (e.g., the probability that a given state i is the initial state).

During inference, the model may use these learned probabilities, along with one or more new parameters and/or hyperparameters discussed in more detail below, to predict the current state and generate appropriate output based on an observation sequence.

In some aspects, during inference, the system can analyze a sequence of data samples (referred to in some aspects as observations, observed outputs, or model inputs) in order to predict or determine, for each observation, the correct state of the model/environment. For example, given a set of observations (where each word may be referred to as an observation or observed output in the sequence), the model may be used to infer the part of speech of each word (e.g., where the part of speech is the “state” that corresponds to the observed word). That is, the model architecture may include a set of states, where each state has corresponding emission probabilities and transition probabilities, and the correct or most-probable state for each observed word can be determined based on the learned parameters.

Generally, at each time step (e.g., for each observation), the model uses the learned emission probabilities and the observation to determine or infer the most-likely state. The learned transition probabilities can similarly be used, in conjunction with the current state and/or observation, to determine or infer the most likely next state. This process can then be repeated for each element in the sequence of observations/for each time step in the model.

In at least one aspect, the probable or predicted next state is determined using Equation 1 below, which can be evaluated for each possible next state, where Probability is a value indicating the probability that a given next state is the correct next state (e.g., where the system selects the minimum or maximum value among the possible next states to determine the “correct” next state), x₀ is an initial state term (discussed in more detail below) indicating the probability that a given state is the initial state, x is a transition term (discussed in more detail below) indicating the probability that a given state is the correct next-state, and γ is an emission term (discussed in more detail below) indicating the probability that a given state is the correct current state, based on the observed output/observation at the current time step. Additionally, in Equation 1, γ (gamma), α (alpha), β (beta), and ζ (zeta) are new parameters or hyperparameters (discussed in more detail below), which may be static/defined (e.g., manually by a user), learned during training (e.g., based on training data) and fixed during inference, and/or dynamically determined during both training and inference (e.g., based on observed data and/or determined states).

$$Probability = - γ {x}_{0} + α x + β y + ζ \qquad ( 1 )$$

By computing Equation 1 at a given time step, the system can effectively determine, infer, or predict the next state from a set of possible next states. Equation 1 can then be applied again at the next time step (using the determined next state as the current state) to predict the subsequent state, and so on until the entire sequence of observed outputs or observations has been evaluated.

In some aspects, x₀ is defined as lnP(Q₀=90), where P(Q₀=q₀) is the probability that the initial state Q₀ is any given/specific state q₀. Additionally, x may be defined as Σₜ₌₀^{T-1}−lnP(Qₜ₊₁=qₜ₊₁|Qₜ=qₜ), where P(Qₜ₊₁=qₜ₊₁|Qₜ=qₜ) is the probability that that the next state Qₜ₊₁ is any given/specific state qₜ₊₁, given that the current state Qₜ is a given/specific state qₜ. That is, the transition term may be used to compute, for each potential next state, the probability that the potential next state is the correct next state. Further, γ may be defined as Σₜ₌₀^{T}-o-lnP(Oₜ|Qₜ=qₜ), where P(Oₜ|Qₜ=qₜ) is the probability that the (actual) observation Oₜ is observed, given that the current state Qₜ is a given/specific state qₜ. That is, the emission term may be used to compute, for each current state, the probability that the observation (reflected in the observation sequence) would be observed, given the current state.

In some aspects, as discussed in more detail below, the parameters γ, α, β, and ζ may be used to improve the accuracy of the model predictions (e.g., the accuracy of the state predictions at each time step). In some aspects, the model architecture may additionally or alternatively be modified in various ways to further improve accuracy, such as by using a machine learning model to train or learn the parameters γ, α, β, and ζ, embedding a machine learning model to replace one or more time steps in the HMM architecture, appending a machine learning model to modify the output of the HMM architecture, training and using a machine learning model to dynamically generate the parameters γ, α, β, and ζ during inference, using a multi-branch architecture with one or more other models in parallel to the HMM model, and the like. Generally, one or more of the disclosed architectures, modifications, and techniques may be used collectively (e.g., within the same model architecture) or separately (e.g., using only a subset of the disclosed techniques within the architecture), depending on the particular implementation.

### Example Workflow for Improved Machine Learning Using Hyperparameters

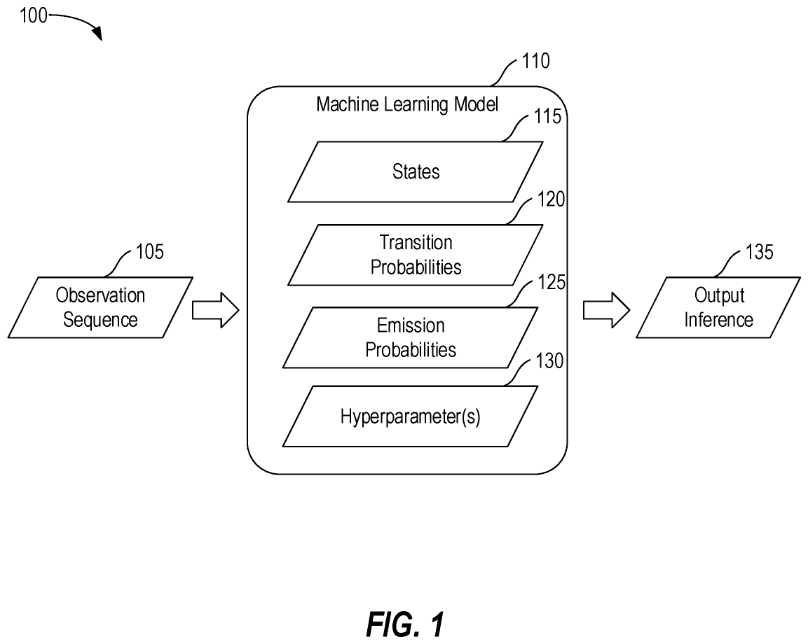

FIG. 1 depicts an example workflow 100 for improved machine learning using hyperparameters.

In the illustrated example, an observation sequence 105 is processed using a machine learning model 110 to generate an output inference 135. In some aspects, the machine learning model 110 corresponds to or comprises an HMM-based architecture (or a modified HMM architecture), as discussed below in more detail. Generally, as discussed above, the observation sequence 105 includes a set or sequence of elements, referred to in some aspects as observed outputs, observations, input samples, and the like. The particular contents and structure of the observation sequence 105 may vary depending on the particular implementation and task. For example, for a part of speech identification task, the observation sequence 105 may include a sequence of words or sentences. For a video classification task, the observation sequence 105 may include a sequence of frames or other video data. For audio evaluation tasks, the observation sequence 105 may include audio information.

Similarly, the contents and structure of the output inference 135 may vary depending on the particular implementation and task. For example, the output inference 135 may include a sequence of inferences or outputs (e.g., a sequence of classifications, one for each element in the observation sequence 105), a single inference or output (e.g., a classification or other value for the entire observation sequence 105), and the like.

As illustrated, the machine learning model 110 generally comprises and/or uses a set of states 115, transition probabilities 120, emission probabilities 125, and hyperparameters 130. The set of states 115 generally comprises or corresponds to the potential states of the model (e.g., the parts of speech). As discussed above, in some aspects, a state from the set of states 115 can be assigned to each element in the observation sequence 105 based on the learned parameters of the machine learning model 110. The transition probabilities 120 may be learned during training of the machine learning model 110, and generally indicate, for each given state 115, a respective probability that one or more other states are the correct next state. In some aspects, the transition probabilities 120 correspond to the transition term x of Equation 1, as discussed above. For example, for a “noun” state, the transition probabilities 120 may indicate the probability that the next state is also the “noun” state, the probability that the next state is a “verb” state, the probability that the next state is an “adjective” state, and so on.

The emission probabilities 125 may similarly be learned during training of the machine learning model 110, and generally indicate, for each given state 115, a respective probability that each possible output will be observed. In some aspects, the emission probabilities 125 correspond to the emission term γ of Equation 1, as discussed above. For example, for a “noun” state, the emission probabilities 125 may indicate the probability that the observed output/word in the observation sequence 105 is the word “the,” the probability that the observed output is the word “word,” the probability that the observed output is the word “writes,” and so on.

In some aspects, the hyperparameters 130 generally correspond to additional values or variables that can be used to generate output inferences, in conjunction with the transition probabilities 120 and emission probabilities 125. For example, the hyperparameters 130 may correspond to γ, α, β, and/or ζ in Equation 1. Generally, the hyperparameters 130 can be defined in a number of ways.

In some aspects, the hyperparameters 130 are used as coefficients for one or more terms in Equation 1. For example, the hyperparameters may include an initial state coefficient (such as γ) for the initial state term, a transition coefficient (such as α) for the transition term, an emission coefficient (such as β) for the emission term, a new linear hyperparameter or term (such as ζ) that is added to the other terms (as compared to a nonlinear hyperparameter or terms (e.g., coefficients), which are multiplied with one or more other terms in the equation), and the like. In some aspects, the hyperparameters 130 can additionally or alternatively include higher-order or more complex terms, such as exponential hyperparameters or terms, quadratic hyperparameters or terms, nonlinear hyperparameters or terms, and/or cross-correlation hyperparameters or terms. For example, the next state may be identified using Equation 2 below, where Probability, γ, x₀, α, x, β, γ, and ζ are defined as above, cx² is a quadratic term including new hyperparameter/coefficient c for squared transition probabilities, dy² is a quadratic term including new hyperparameter/coefficient d for the squared emission probabilities, and exy is a cross-correlation term between the transition and emission probabilities, including new hyperparameter/coefficient e.

$$Probability = - γ {x}_{0} + α x + β y + {cx}^{2} + {dy}^{2} + exy + ζ \qquad ( 2 )$$

In some aspects, the hyperparameters may additionally or alternatively include nonlinear hyperparameters or terms. For example, rather than directly incorporating a hyperparameter or coefficient α (e.g., as a coefficient), Equation 2 may incorporate this new hyperparameter a using nonlinear functions such as exponential (e.g., exp(α)), log or natural log (e.g., ln(α)), hyperbolic tangential (e.g., tan h(a), αⁿ where n is another hyperparameter, a rectified linear unit (e.g., ReLu(α)), a sigmoid function (e.g., sigmoid(α)), a softmax function (e.g., softmax(α)), and the like.

In some aspects, the hyperparameters 130 may additionally or alternatively be used to defined joint probabilities if there is dependency between terms, such as using Equation 3 below, where Probability, γ, x₀, α, x, β, γ, and ζ are defined as above, c is a new hyperparameter/coefficient for the joint probability term, and P(Qₜ₊₁=qₜ₊₁, Oₜ=qₜ|Qₜ=qₜ) corresponds to the joint probability between the transition and emission terms.

$$Probability = - γ {x}_{0} + α x + β y + c \sum - ln P ( {Q}_{t + 1} = {q}_{t + 1} , {O}_{t} = {q}_{t} \vert {Q}_{t} = {q}_{t} ) \qquad ( 3 )$$

In some aspects, one or more of the hyperparameters 130 are manually defined or curated. For example, a user (e.g., a subject matter expert) may specify a value for one or more hyperparameters 130 to be used as coefficients in the log likelihood Equations 1, 2 and/or 3. Generally, the hyperparameters 130 may be defined universally (e.g., with the same values for each state in the model and/or for each time step in the observed sequence) or with differing values for each state and/or for each time step.

In some aspects, one or more of the hyperparameters 130 can be learned during training of the machine learning model 110. For example, the system may use various supervised, semi-supervised, and/or unsupervised techniques to fine-tune the hyperparameters 130 (e.g., coefficients) for the transition probabilities 120, emission probabilities 125, and the like. For example, in some aspects, a small neural network may be used to refine the hyperparameters 130 based on training data (e.g., based on training observation sequences used as input and corresponding ground-truth inferences/states).

In some aspects, a neural network (or other model architecture) can receive, as input, a sequence of elements (e.g., the observations) to generate values for one or more hyperparameters (e.g., one or more for the emission probability and/or one or more for the transition probability). In at least one aspect, such a model can be trained once the HMM portion(s) of the architecture stabilizes (e.g., once the emission and transition probabilities are no longer changing above a defined threshold between rounds). In some aspects, during training of such a model, the target ground truth of the small model (e.g., appropriate hyperparameters) may be known, and the small model can be trained based on this knowledge to enable optimization of the hyperparameters for similar use cases.

In some aspects, the neural network (or other architecture) used to generate the hyperparameters (or the hyperparameters themselves) can additionally or alternatively be refined using continual learning (also referred to in some aspects as online learning or inference learning). For example, during inferencing, continual learning can be used to refine or update the hyperparameters and/or the parameters of the small model that generates the hyperparameters (e.g., periodically or continuously) to provide continuous improvement and adaptation of the architecture. In some aspects, the ground truth used during continual learning can be provided or accessed from a variety of sources such as directly from a user, inferred based on user actions or responses, or via one or more sensors.

In some aspects, if the hyperparameters 130 are learned, then the hyperparameters may be learned universally (e.g., with the same values for each state or time step in the model) or with differing values for each state or time step. In some aspects, once the hyperparameters 130 are learned during training, the hyperparameters may remain fixed for inferencing.

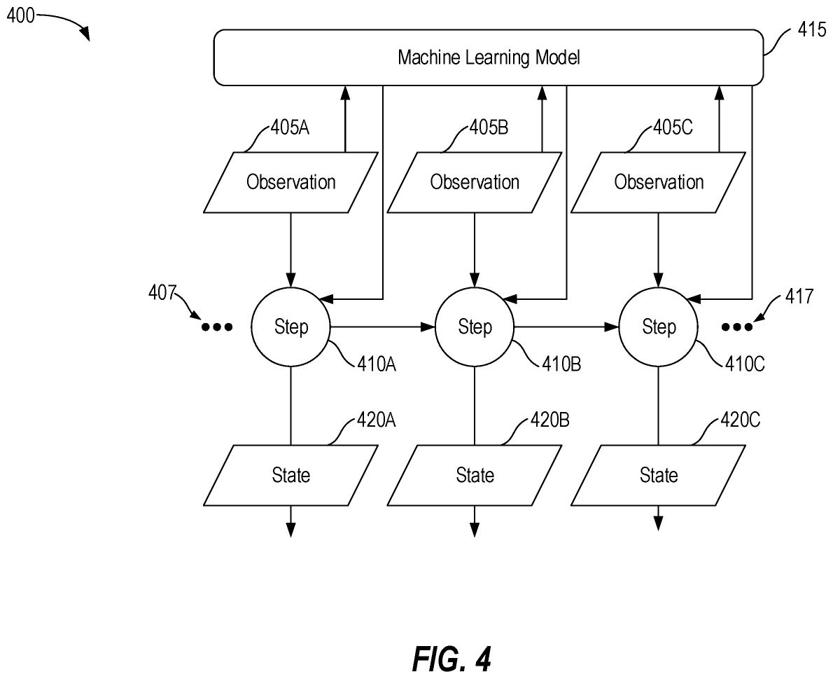

In some aspects, one or more of the hyperparameters 130 may be dynamically generated based on input data during training/inferencing. For example, at each time step, the observed output sample (in the observation sequence 105) may be provided as input not only to the machine learning model 110 itself (e.g., to determine the current and/or next state), but also to a separate machine learning component (e.g., a small neural network) that generates output value(s) to be used as the hyperparameters 130 for the current time step, as discussed in more detail below with reference to FIG. 4.

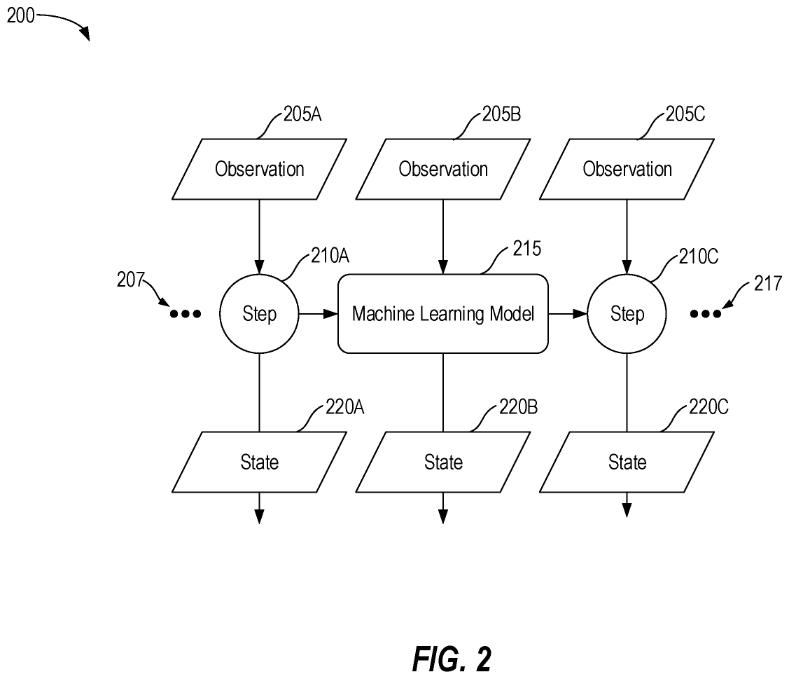

In some aspects, in addition to the states 115, the machine learning model 110 can use additional architectures or components to further modify and improve the prediction accuracies. For example, in some aspects, one or more time steps may be replaced with a separate machine learning model or component (e.g., a small neural network) rather than using the transition probabilities 120 and emission probabilities 125 for the step. For example, after training, the distributions of the transition and/or emission probabilities may be evaluated to find regions (e.g., time steps) that converge and have little or no meaningful output. For example, the system may determine that the transition and/or emission probabilities for the second and third elements/steps in the observation sequence meet one or more impact criteria (e.g., determining that the probabilities for these steps have little or no impact on the output inference 135), and the system may therefore determine to train and use a lightweight neural network or other model during these time steps, as discussed in more detail below with reference to FIG. 2.

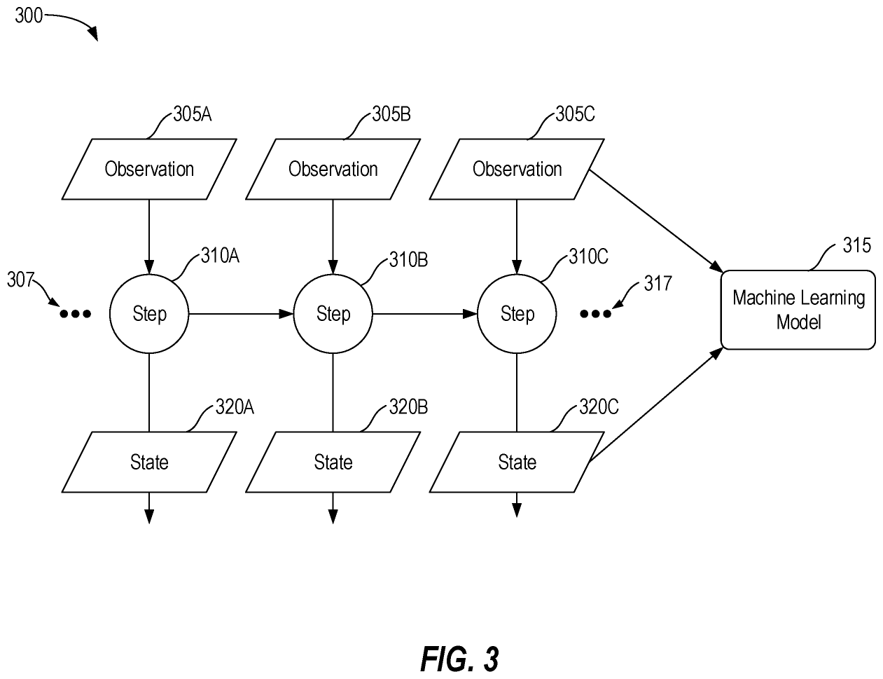

In some aspects, the machine learning model 110 may include one or more additional machine learning models or components appended to the output of the HMM. For example, as discussed below in more detail with reference to FIG. 3, the observations and/or predicted state(s) generated at one or more time steps may be processed using a separate model (e.g., a lightweight neural network) to generate the actual output inference(s) 135 from the machine learning model 110.

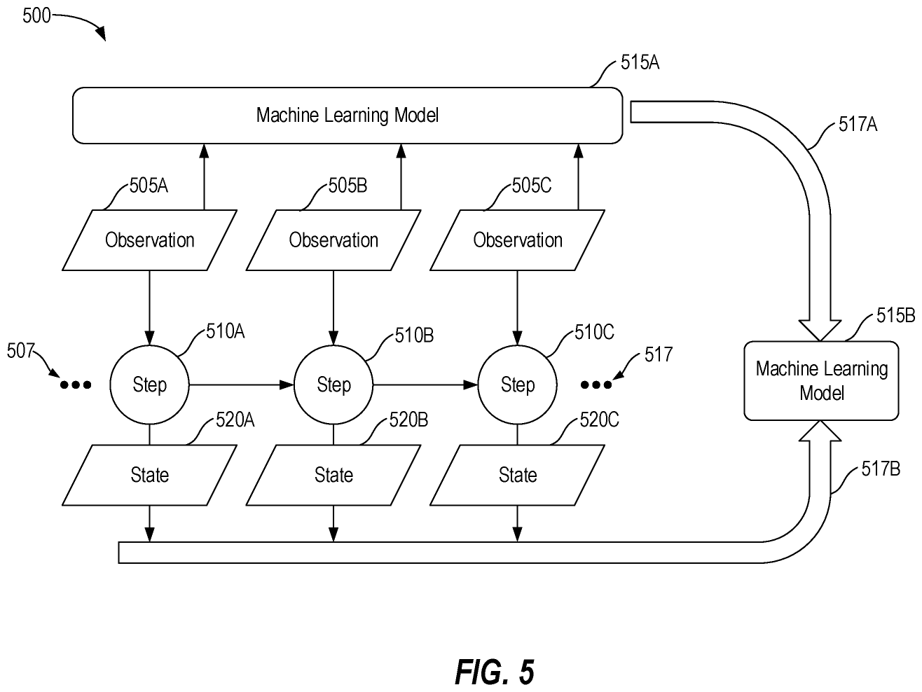

In some aspects, the machine learning model 110 may include one or more additional machine learning models or components in a multi-branch architecture. For example, as discussed below in more detail with reference to FIG. 5, the observation sequence may be processed using both an HMM as well as a separate model (e.g., a recurrent neural network (RNN)), and the resulting outputs from each (e.g., a sequence of predicted states) can be aggregated or evaluated (e.g., using a lightweight neural network or a multilayer perceptron (MLP)) to generate the actual output inference(s) 135 from the machine learning model 110.

As discussed above, the various architectures and techniques described herein may be combined in any suitable combination. For example, the machine learning model 110 may use any combination of manually defined hyperparameters 130, learned hyperparameters 130, and/or dynamically generated hyperparameters 130. Similarly, the machine learning model 110 may use any combination of embedded model components (e.g., discussed with reference to FIG. 2), appended components (e.g., discussed with reference to FIG. 3), multi-branch components (e.g., discussed with reference to FIG. 5), and the like.

Generally, using aspects of the present disclosure, the machine learning model 110 is able to provide more accurate output inferences 135, as compared to some conventional solutions. Further, in some aspects, the output inferences 135 can be generated with reduced or similar computational expense, as compared to some conventional solutions. In some aspects, the techniques described herein enable the machine learning model 110 to be trained using reduced computational expense and/or reduced training data, as compared to some conventional solutions.

### Example Machine Learning Architecture with an Embedded Machine Learning Model

FIG. 2 depicts an example machine learning architecture 200 with an embedded machine learning model 215. In some aspects, the architecture 200 depicts a portion of an HMM-based architecture, such as the machine learning model 110 of FIG. 1. In some aspects, the architecture 200 may be referred to as a hybrid architecture, network, or model because it is a hybrid of an HMM and another architecture (e.g., and a neural network).

In the illustrated example, the architecture 200 includes a sequence of steps 210A-C (collectively, steps 210, also referred to in some aspects as time steps), where each step 210 corresponds to an observation 205 in a sequence of observed outputs (e.g., in the observation sequence 105 of FIG. 1). Specifically, at each step 210 of the architecture 200, a corresponding observation 205 and/or the current state (e.g., determined by a previous step) is used as input to generate a predicted next state 220 (e.g., the inferred or predicted state, such as one of the states 115 of FIG. 1).

As discussed above, the architecture 200 can be used to model a system where, at each (hidden or unknown) state, a given observation or emission was generated/output. The architecture 200 seeks to use these observations (as well as the previously generated or inferred state(s) in some aspects) as inputs at each time step 210 to predict or infer the corresponding (next) hidden state in the system. As illustrated, each step 210 may be referred to as a “step” or “time step” to indicate that it corresponds to/is used to process a corresponding observation 205 in the sequence. That is, a first observation 205A is processed using learned parameters for a first step 210A, and so on. Although not depicted in the illustrated example, in some aspects, the state 220 generated by a given step 210 may also be used as input to the subsequent step 210 (along with the new observation 205).

For example, based on the observation 205, the determined current state (e.g., determined by the previous step of the architecture 200), and/or one or more hyperparameters (such as hyperparameters 130 of FIG. 1), the architecture 200 can identify the most-probable next state 220. In some aspects, as discussed above, the next state 220 is determined using one or more log likelihood equations, such as Equations 1, 2, and/or 3 above. As illustrated, each state 220 can be used as output from the architecture 200 and/or may be processed by one or more other components or systems to generate model output. For example, if the architecture 200 is used to provide part of speech recognition, each generated state 220 may indicate the part of speech of a corresponding observation 205 (which may be the observation 205 used as input to the step 210 that generated the state 220, or may be the observation 205 used as input to the prior step 210).

Specifically, in the illustrated example, at step 210A, an observation 205A is evaluated to predict the state 220A. In some aspects, as indicated by the ellipses 207, there may be any number of steps prior to the step 210A. That is, the step 210A may be the first step (e.g., where the “current” state is determined using the initial state term as discussed above), or may be a subsequent time step (e.g., where the “current” state is determined by a prior step 210). As illustrated, the state 220A corresponds to the predicted next state (which acts as the current state for the next time step), and is determined based in part on the state generated by the prior step.

As illustrated, for the subsequent time step, rather than using a step 210, the architecture 200 includes a machine learning model 215 (e.g., a small or lightweight neural network classifier or other model, such as a small convolutional neural network, a recurrent neural network, a long short-term memory (LSTM) model, a gated recurrent unit (GRU) model, and the like) to generate the state 220B based on observation 205B and/or the generated state 220A (from the prior step), without using the transition probabilities and the emission probabilities. That is, rather than evaluating the current observation 205B and previously determined state 220A using a log likelihood equation (e.g., Equations 1, 2 and/or 3) and learned emission probabilities and transition probabilities, the machine learning model 215 may be a small neural network classifier that uses learned weights (learned during training) to generate a state 220B based at least in part on the observation 205B. Although not included in the depicted example, in some aspects, the machine learning model 215 may also receive the previously generated state 220A (generated during the prior step) as input to generate the observation 205B.

In at least one aspect, as discussed above, the machine learning model 215 may be used to replace steps 210 with non-meaningful output (e.g., as determined based on the learned transition and/or emission probabilities for the step). For example, as discussed above, during or after training, it may be determined that the next state for a given time step does not vary (or varies below a threshold). That is, such steps may not produce meaningful output because the generated next state does not vary (or varies very little) based on the input observation and/or prior state. In some aspects, in response to determining that the transition and/or emission probabilities for a particular step are not meaningful, the machine learning model 215 may be trained and embedded to replace this step. Advantageously, the machine learning model 215 may be able to generate inferences (e.g., state 220B) more efficiently, more rapidly, and/or with reduced computational expense, as compared to a conventional step 210. Further, in some aspects, the machine learning model 215 may enable the architecture 200 to produce more accurate output, as compared to conventional models. In this way, inferencing using the architecture 200 can be more efficient, more accurate, and/or quicker than some conventional HMM architectures.

As illustrated, the output of the machine learning model 215 (e.g., state 220B) can be used as the output inference from the architecture 200 at the time step for observation 205B, as well as used as input to the next step 210C. The step 210C, in a similar manner to the step 210A, can use the current observation 205C to generate a next state 220C (e.g., based on emission probabilities, transition probabilities, and/or hyperparameters, as discussed above). Though not depicted in the illustrated example, in some aspects, the next state 220C is generated (at step 210C) based further on the determined state 220B. As indicated by ellipses 217, there may be any number of time steps subsequent to the step 210C.

Although a single machine learning model 215 is depicted for conceptual clarity in the architecture 200, in some aspects, a single architecture may include multiple embedded machine learning models used to replace multiple discrete steps 210. Further, although the illustrated machine learning model 215 corresponds to a single time step (e.g., used to process observation 205B), in some aspects, the machine learning model 215 may be used for multiple sequential time steps (e.g., used to process both the observation 205B and the observation 205C, and generate states 220B and 220C).

As discussed above, the states 220 can then be used for a variety of purposes, including providing the sequence of predicted states 220 as the output inference (e.g., output inference 135 of FIG. 1) from the architecture 200. Additionally or alternatively, the state(s) 220A-C may be aggregated or evaluated to generate an overarching inference for the sequence of observations 205A-C, such as a classification for the observation sequence.

### Example Machine Learning Architecture with an Appended Machine Learning Model

FIG. 3 depicts an example machine learning architecture 300 with an appended machine learning model. In some aspects, the architecture 300 depicts a portion of an HMM-based architecture, such as the machine learning model 110 of FIG. 1.

In the illustrated example, the architecture 300 includes a sequence of steps 310A-C (collectively, steps 310, also referred to in some aspects as time steps), where each step 310 corresponds to an observation 305 in a sequence of observed outputs (e.g., in the observation sequence 105 of FIG. 1). For example, the architecture 300 may include an HMM-based architecture. Specifically, at each step 310 of the architecture 300, a corresponding observation 305 and/or the current state (e.g., determined by a previous step) is used to generate a predicted next state 320.

As discussed above with reference to FIG. 2, the architecture 300 may be used to model a system where, at each (hidden or unknown) state, a given observation or emission was generated/output. The architecture 300 seeks to use these observations (as well as the previously generated or inferred state(s) in some aspects) as inputs at each step 310 to predict or infer the corresponding (next) hidden state in the system. As illustrated, each step 310 may be referred to as a “step” or “time step” to indicate that it corresponds to/is used to process a corresponding observation 305 in the sequence. That is, a first observation 305A is processed using learned parameters for a first step 310A, and so on. Although not depicted in the illustrated example, in some aspects, the state 320 generated by a given step 310 may also be used as input to the subsequent step 310 (along with the new observation 305).

For example, based on the observation 305, the determined current state (e.g., determined by the previous step of the architecture 300), and/or one or more hyperparameters (such as hyperparameters 130 of FIG. 1), the architecture 300 can identify the most-probable next state 320. In some aspects, as discussed above, the next state 320 is determined using one or more log likelihood equations, such as Equations 1, 2, and/or 3 above.

Specifically, in the illustrated example, at step 310A, an observation 305A is evaluated to predict the next state 320A. In some aspects, as indicated by the ellipses 307, there may be any number of steps prior to the step 310A. That is, the step 310A may be the first step (e.g., where the “current” state is determined using the initial state term as discussed above), or may be a subsequent time step (e.g., where the “current” state is determined by a prior step 310). As illustrated, the state 320A corresponds to the next state (which acts as the current state for the next time step), and is determined based in part on the state generated by the prior step.

In some aspects, as discussed above, at step 310A, the current observation 305A and previously determined current state may be evaluated using a log likelihood equation (e.g., Equations 1, 2 and/or 3) and learned emission probabilities, transition probabilities, and/or hyperparameters (e.g., hyperparameters 130 of FIG. 1) to predict the next state 320A.

Similarly, at step 310B, observation 305B and state 320A are used (alongside learned transition and emission probabilities and/or hyperparameters) to generate the next state 320B, which is used alongside the observation 305C at step 310C to generate state 320C (similarly using learned transition and emission probabilities and/or hyperparameters). As indicated by ellipses 317, there may be any number of time steps subsequent to the step 310C.

In the illustrated example, rather than using the generated or predicted states 320A-C as the model output, the architecture 300 further includes a machine learning model 315 that accesses and processes one or more of the states 320 and/or one or more of the observations 305 to generate the output inference (e.g., output inference 135 of FIG. 1) for the architecture 300.

For example, in some aspects, the machine learning model 315 is a lightweight model (e.g., a small neural network, a convolutional neural network, a recurrent neural network, a long short-term memory (LSTM) model, a gated recurrent unit (GRU) model, and the like) that generates the output of the architecture 300. In some aspects, the machine learning model 315 processes both observation(s) 305 and state(s) 320 to generate the architecture output. In some aspects, the machine learning model 315 may process only the predicted state(s) 320 (rather than processing the observations 305 themselves). Additionally, in some aspects, the machine learning model 315 processes each state 320 individually (e.g., as the state 320 is generated/predicted) to generate a corresponding output for the time step. For example, for a first time step corresponding to observation 305A, the machine learning model 315 may process state 320A to generate an output inference for the first time step.

In some aspects, the machine learning model 315 may additionally or alternatively process a set of data (e.g., the set or sequence of predicted states 320) to generate an overall or aggregate output inference for the architecture 300.

In at least one aspect, the machine learning model 315 receives, as input, the sequence of predicted states 320 and observations 305 and/or a subset therefrom. For example, in some aspects, the machine learning model 315 is used to process subsets of the model output, such as for steps 310 or portions where the HMM architecture has issues (such as low accuracy or confidence). In some aspects, the machine learning model 315 can effectively replace or supplement the overall output to ameliorate such concerns. In some aspects, if one or more subsets of the model output (e.g., steps 310) are known to be computationally expensive and/or to be computationally sparse, the system may replace those portions with output from the machine learning model 315 to reduce power dissipation and/or complexity of computations.

In some aspects, the machine learning model 315 may be trained while training the HMM architecture (e.g., passing losses through the machine learning model 315 and the HMM steps 310), or may be trained separately. For example, in some aspects, the machine learning model 315 is used to provide domain adaptation using target data. For example, the HMM may be trained (e.g., learning the emission and transition probabilities), and the machine learning model 315 may then be trained or refined to receive the HMM output (e.g., the states 320) to generate final inference output using training or refining data for the specific target domain. Similarly, the machine learning model 315 may be used to provide on-device learning for edge devices or other computationally constrained devices. Generally, by adaptively modifying the HMM output, the machine learning model 315 can be used to provide more accurate inferences, as compared to some conventional solutions.

### Example Machine Learning Architecture with Dynamic Hyperparameters Using a Machine Learning Model

FIG. 4 depicts an example machine learning architecture 400 with dynamic hyperparameters using a machine learning model. In some aspects, the architecture 400 depicts a portion of an HMM-based architecture, such as the machine learning model 110 of FIG. 1.

In the illustrated example, the architecture 400 includes a sequence of steps 410A-C (collectively, steps 410, also referred to in some aspects as time steps), where each step 410 corresponds to an observation 405 in a sequence of observed outputs (e.g., in the observation sequence 105 of FIG. 1). For example, the architecture 400 may include an HMM-based architecture. Specifically, at each step 410 of the architecture 400, a corresponding observation 405 and/or the current state (e.g., determined by a previous step) is used to generate a predicted next state 420 (e.g., the inferred or predicted state, such as one of the states 115 of FIG. 1). For example, based on the observation 405, the determined current state (e.g., determined by the previous step of the architecture 400), and/or one or more hyperparameters (such as hyperparameters 130 of FIG. 1), the architecture 400 can identify the most-probable next state 420. In some aspects, as discussed above, the next state 420 is determined using one or more log likelihood equations, such as Equations 1, 2, and/or 3 above.

Specifically, in the illustrated example, at step 410A, an observation 405A and/or prior-determined current state is evaluated to predict the next state 420A. In some aspects, as indicated by the ellipses 407, there may be any number of steps prior to the step 410A. As illustrated, the state 420A corresponds to the predicted next state (which acts as the current state for the next time step). In some aspects, as discussed above, at the step 410A, the current observation 405A and previously determined state may be evaluated using a log likelihood equation (e.g., Equations 1, 2 and/or 3) and learned emission probabilities, transition probabilities, and/or hyperparameters (e.g., hyperparameters 130 of FIG. 1).

Similarly, at step 410B, observation 405B and state 420A are used (alongside learned transition and emission probabilities and/or hyperparameters) to generate the next state 420B, which is used alongside the observation 405C at step 410C to generate state 420C (similarly using learned transition and emission probabilities and/or hyperparameters). As indicated by ellipses 417, there may be any number of time steps subsequent to the step 410C.

In the illustrated example, at each step 410, the corresponding observation 405 is further accessed and processed by a machine learning model 415 (e.g., a small or lightweight neural network), which evaluates the observation 405 to generate one or more additional weights or other values (e.g., parameters or hyperparameters) that are used by the corresponding step 410 to generate the state 420. For example, as discussed above with reference to Equations 1, 2, and 3, one or more of the hyperparameters γ, α, β, and/or ζ may be dynamically generated (by the machine learning model 415) based on the observation 405 for each time step.

Specifically, at a first time step, the observation 405A is processed by the machine learning model 415 to generate a new parameter or hyperparameter, which is then used at the step 410A (alongside other parameters, such as the emission probabilities and the transition probabilities) to generate the predicted state 420A. At a second time step, the observation 405B is processed by the machine learning model 415 to generate a new parameter or hyperparameter, which is then used at the step 410B (alongside other parameters, such as the emission probabilities and the transition probabilities) to generate the predicted state 420B. Further, at a third time step, the observation 405C is processed by the machine learning model 415 to generate a new parameter or hyperparameter, which is then used at the step 410C (alongside other parameters, such as the emission probabilities and the transition probabilities) to generate the predicted state 420C.

As discussed above, the architecture 400 thereby enables dynamic parameter or hyperparameters to be generated and used at each time step of the HMM-based architecture, improving the accuracy of the generated predictions (e.g., the predicted states 420).

The states 420 can then be used for a variety of purposes, including providing the sequence of predicted states 420 as the output inference (e.g., output inference 135 of FIG. 1) from the architecture 400. Additionally or alternatively, the state(s) 420A-C may be aggregated or evaluated to generate an overarching inference for the sequence of observations 405A-C, such as a classification for the observation sequence.

### Example Multi-Branch Machine Learning Architecture with a Fusion Machine Learning Model

FIG. 5 depicts an example multi-branch machine learning architecture 500 with a fusion machine learning model. In some aspects, the architecture 500 depicts a portion of an HMM-based architecture, such as the machine learning model 110 of FIG. 1.

In the illustrated example, the architecture 500 includes a sequence of steps 510A-C (collectively, steps 510, also referred to in some aspects as time steps), where each step 510 corresponds to an observation 505 in a sequence of observed outputs (e.g., in the observation sequence 105 of FIG. 1). For example, the architecture 500 may include an HMM-based architecture. Specifically, at each step 510 of the architecture 500, a corresponding observation 505 and/or the current state (e.g., determined by a previous step) is used to generate a predicted next state 520 (e.g., the inferred or predicted state, such as one of the states 115 of FIG. 1). For example, based on the observation 505, the determined current state (e.g., determined by the previous step of the architecture 500), and/or one or more hyperparameters (such as hyperparameters 130 of FIG. 1), the architecture 500 can identify the most-probable next state 520. In some aspects, as discussed above, the next state 520 is determined using one or more log likelihood equations, such as Equations 1, 2, and/or 3 above.

Specifically, in the illustrated example, at step 510A, an observation 505A is evaluated to predict the next state 520A. In some aspects, as indicated by the ellipses 507, there may be any number of steps prior to the step 510A. As illustrated, the state 520A corresponds to the next state (which acts as the current state for the next time step). In some aspects, as discussed above, at the step 510A, the current observation 505A and previously determined state or the initial state may be evaluated using a log likelihood equation (e.g., Equations 1, 2 and/or 3) and learned emission probabilities, transition probabilities, and/or hyperparameters (e.g., hyperparameters 130 of FIG. 1).

Similarly, at step 510B, observation 505B and state 520A are used (alongside learned transition and emission probabilities and/or hyperparameters) to generate the next state 520B, which is used alongside the observation 505C at step 510C to generate state 520C (similarly using learned transition and emission probabilities and/or hyperparameters). As indicated by ellipses 517, there may be any number of time steps subsequent to the step 510C.

In the illustrated example, at each step 510, the corresponding observation 505 is further accessed and processed by a machine learning model 515A, which evaluates the observation 505 to generate one or more outputs. That is, in addition to using the HMM-based architecture to generate the predicted states 520, the machine learning model 515A uses the observations 505 to generate its own output. In some aspects, the machine learning model 515A corresponds to an architecture that processes time series data to generate output. For example, the machine learning model 515A may comprise a recurrent neural network.

In the illustrated architecture 500, the output of the machine learning model 515A and the output of the HMM components (e.g., the predicted states 520) are provided to a second machine learning model 515B, which evaluates them to generate the overall output inference (e.g., output inference 135 of FIG. 1) for the architecture 500.

In some aspects, the machine learning model 515B generates an output for each observation 505/state 520. That is, for each observation 505, the machine learning model 515A may generate a corresponding output that is processed, alongside the state 520 generated at the same time step, by the machine learning model 515B to generate the model output for that time step. In other aspects, the machine learning model 515B may generate an output based on the collection of outputs from the machine learning model 515A (for the given observation sequence) and the sequence of predicted states 520 for the observation sequence. In at least one aspect, the machine learning model 515B comprises a MLP.

As discussed above, the architecture 500 thereby enables fusion across different components (e.g., an HMM and an RNN) to increase flexibility and configurability, and generally improve the accuracy of the predictions generated by the architecture 500.

### Example Method for Improved Machine Learning

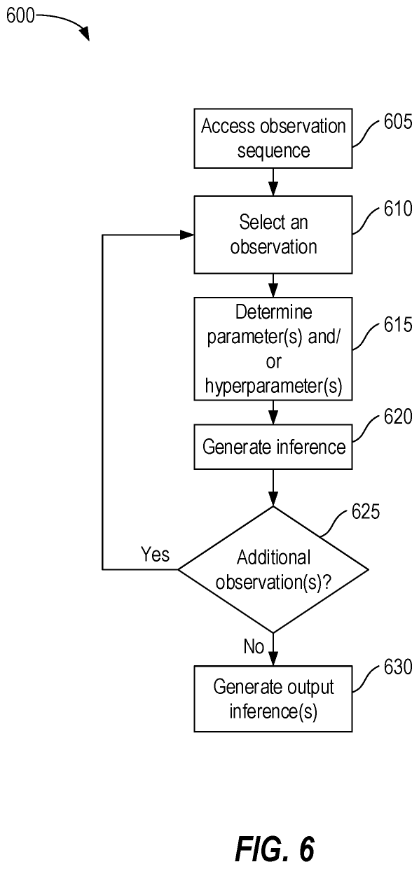

FIG. 6 is a flow diagram depicting an example method 600 for improved machine learning. In some aspects, the method 600 provides additional detail for using an HMM-based architecture, such as the machine learning model 110 of FIG. 1, the architecture 200 of FIG. 2, the architecture 300 of FIG. 3, the architecture 400 of FIG. 4, and/or the architecture 500 of FIG. 5.

In some aspects, the method 600 is used during inferencing to generate output sequences (e.g., predicted states) based observation sequences (e.g., observation sequence 105 of FIG. 1). In some aspects, the method 600 is used during training (e.g., during a forward pass) to generate output predictions, which can then be compared against known or ground-truth data (e.g., a ground-truth sequence of states) to refine the model(s). That is, the method 600 may be used by a machine learning system for inferencing (referred to in some aspects as an inferencing system) and/or for training (referred to in some aspects as a training system).

At block 605, the machine learning system accesses a sequence of observations (e.g., observation sequence 105 of FIG. 1). As discussed above, the sequence may generally include one or more data elements, such as a sequence of words or other observations, that can be evaluated to generate a prediction (e.g., a predicted sequence or set of states). Generally, as discussed above, the particular contents of the sequence may vary depending on the particular implementation and solution.

At block 610, the machine learning system selects one of the observations in the sequence. Generally, the machine learning system may select the observation using any suitable technique or criteria. In at least one aspect, the machine learning system selects the observations sequentially. That is, if the accessed observations have a defined sequence or ordering, then the machine learning system can select them in the defined order (e.g., selecting the observation at the first index first, followed by the observation at the second index, and so on).

At block 615, the machine learning system determines a set of parameters and/or hyperparameters to be used to process the selected observation. For example, as discussed above, the machine learning system may determine the transition probabilities and/or emission probabilities that were learned during training for the hybrid HMM-based architecture. In some aspects, as discussed above, the particular parameter(s) and/or hyperparameters to be used may vary depending on the particular implementation and/or the particular time step or index of the selected observation.

For example, the machine learning system may determine whether the index of the selected observation/current step uses an HMM-based architecture, or a different architecture (such as the embedded machine learning model 215 of FIG. 2). The machine learning system can then access the appropriate parameters and/or hyperparameters for the current step. In some aspects, as discussed above, determining the parameters and/or hyperparameters may further include determining or accessing defined values used by the HMM-based architecture, such as defined and/or learned hyperparameters 130 of FIG. 1 (e.g., γ, α, β, and/or ζ) In some aspects, as discussed above, such hyperparameters γ, α, β, and/or ζ may be referred to alternatively as parameters or hyperparameters, depending on the particular implementation (e.g., depending on whether the hyperparameters are learned, dynamically generated, or defined/fixed during training).

In some aspects, determining the parameters may further include generating one or more parameters. For example, as discussed above with reference to FIG. 4, the machine learning system may use a lightweight machine learning model to generate dynamic values for one or more coefficients or other parameters used at the time step.

In some aspects, determining the parameters may further include accessing parameters of one or more other components, such as discussed above with reference to FIG. 5. For example, in addition to accessing HMM-specific parameters (such as the emission and transition probabilities), the machine learning system may further access parameters of a parallel or multi-branch component (e.g., an RNN).

At block 620, the machine learning system generates one or more inferences for the selected observation based on the determined parameter(s) and/or hyperparameter(s). Generally, as discussed above, the particular technique(s) used to generate the inference for the current step (based on the selected observation) may vary depending on the particular implementation.

For example, in some aspects, the generated inference may be a predicted next state, as discussed above. In some aspects, the machine learning system generates the inference at least in part based on Equations 1, 2, and/or 3 above. That is, the machine learning system may generate the next state based on the selected observation, the “current” state (generated in the prior iteration), one or more probabilities (e.g., transition probabilities and emission probabilities), and/or one or more hyperparameters. In some aspects, the machine learning system may use an embedded classifier to generate the next state at the current time step. In some aspects, as discussed above, the machine learning system may additionally or alternatively generate other output, such as using machine learning model 515A of FIG. 5 in a multi-branch architecture.

At block 625, the machine learning system determines whether there is at least one additional observation remaining in the accessed sequence of observations (or at least one time step remaining in the model). If so, then the method 600 returns to block 610 to select the next observation. If not, then the method 600 continues to block 630.

At block 630, the machine learning system generates one or more output inferences for the architecture. In some aspects, as discussed above, the inference(s) generated at block 620 may be used directly as the output inference (e.g., as a sequence of predicted states). In some aspects, as discussed above, the inference(s) generated at block 620 may be further processed using one or more other components, such as to generate an overall classification for the sequence of states.

In some aspects, as discussed above, this generated or predicted state at each time step may be processed by one or more other components to generate the output inference(s). For example, as discussed above with reference to FIG. 3, the predicted state may be processed using an appended machine learning component (e.g., machine learning model 315) to refine the predicted state and generate the final output for the time step. As another example, in a multi-branch architecture (such as the architecture 500 of FIG. 5) the predicted state may be processed by another component (such as machine learning model 515B of FIG. 5) to generate the output inference for the time step.

In this way, the method 600 can provide dynamic and efficient model predictions with improved accuracy and/or reduced computational expense, as compared to some conventional solutions.

### Example Method for Generating Output Inferences Using Improved HMM-Based Models

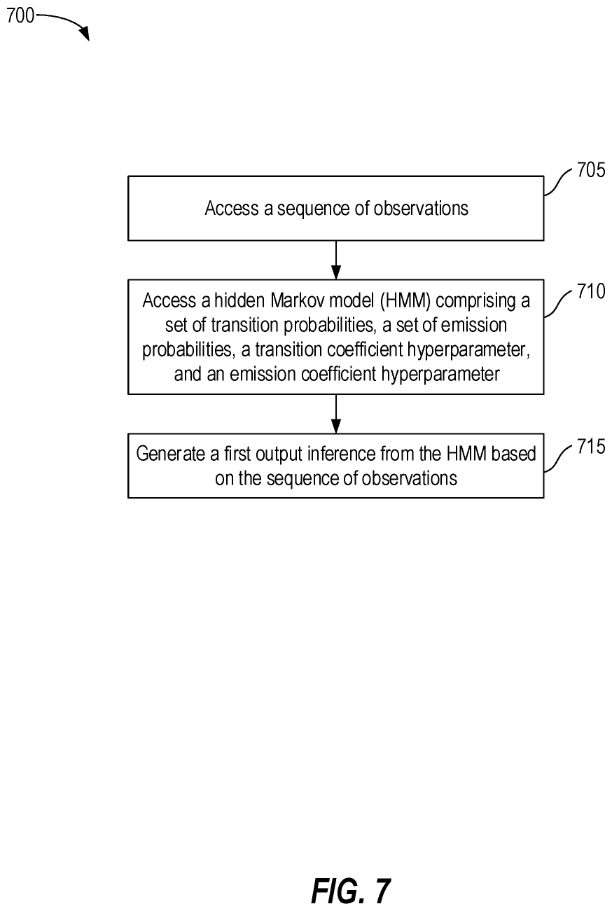

FIG. 7 is a flow diagram depicting an example method 700 for generating output inferences using improved HMM-based models. In some aspects, the method 700 provides additional detail for using an HMM-based architecture, such as the machine learning model 110 of FIG. 1, the architecture 200 of FIG. 2, the architecture 300 of FIG. 3, the architecture 400 of FIG. 4, and/or the architecture 500 of FIG. 5.

At block 705, a sequence of observations is accessed.

At block 710, a hidden Markov model (HMM) comprising a set of transition probabilities, a set of emission probabilities, a transition coefficient hyperparameter, and an emission coefficient hyperparameter is accessed.

At block 715, a first output inference from the HMM is generated based on the sequence of observations.

In some aspects, the HMM further comprises a linear hyperparameter.

In some aspects, the transition coefficient hyperparameter and the emission coefficient hyperparameter were learned based on training data while training the HMM.

In some aspects, the method 700 further includes refining the transition coefficient hyperparameter and the emission coefficient hyperparameter using continual learning based on the first output inference.

In some aspects, the method 700 further includes generating the transition coefficient hyperparameter and the emission coefficient hyperparameter based on one or more observations of the sequence of observations.

In some aspects, generating the transition coefficient hyperparameter and the emission coefficient hyperparameter comprises processing the one or more observations of the sequence of observations using a neural network.

In some aspects, the HMM further comprises at least one of: a cross-correlation hyperparameter, a quadratic hyperparameter, or a nonlinear hyperparameter.

In some aspects, at least one output inference from the HMM is generated using one or more transition probabilities and one or more emission probabilities, and at least one output inference from the HMM is generated using a neural network classifier that does not use the set of transition probabilities and the set of emission probabilities.

In some aspects, the method 700 further includes generating an output inference, wherein generating the output inference includes processing the first output inference of the HMM using a neural network.

In some aspects, the method 700 further includes generating a second output inference, wherein generating the second output inference includes processing the sequence of observations using a recurrent neural network (RNN), and generating an overall output inference, wherein generating the overall output inference includes processing the first and second output inferences using a multilayer perceptron (MLP).

### Example Processing System for Efficient Machine Learning

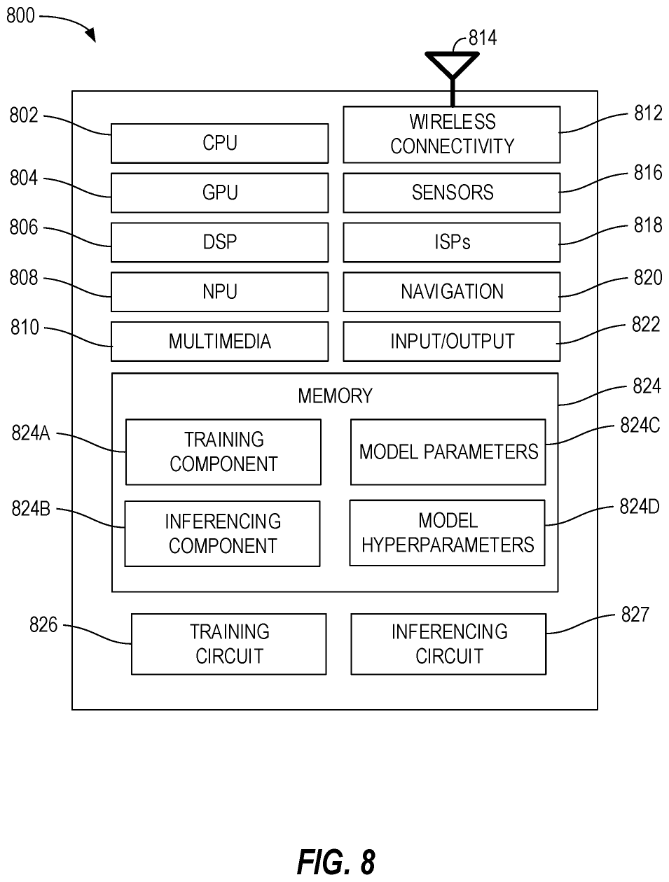

In some aspects, the workflows, architectures, techniques, and methods described with reference to FIGS. 1-7 may be implemented on one or more devices or systems. FIG. 8 depicts an example processing system 800 configured to perform various aspects of the present disclosure, including, for example, the techniques and methods described with respect to FIGS. 1-7. In some aspects, the processing system 800 may train, implement, or provide machine learning models using HMM-based architectures, such as the machine learning model 110 of FIG. 1, the architecture 200 of FIG. 2, the architecture 300 of FIG. 3, the architecture 400 of FIG. 4, and/or the architecture 500 of FIG. 5. Although depicted as a single system for conceptual clarity, in at least some aspects, as discussed above, the operations described below with respect to the processing system 800 may be distributed across any number of devices.

Processing system 800 includes a central processing unit (CPU) 802, which in some examples may be a multi-core CPU. Instructions executed at the CPU 802 may be loaded, for example, from a program memory associated with the CPU 802 or may be loaded from a partition of memory 824.

Processing system 800 also includes additional processing components tailored to specific functions, such as a graphics processing unit (GPU) 804, a digital signal processor (DSP) 806, a neural processing unit (NPU) 808, a multimedia processing unit 810, and a wireless connectivity component 812.

An NPU, such as NPU 808, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as NPU 808, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new data through an already trained model to generate a model output (e.g., an inference).

In some implementations, NPU 808 is a part of one or more of CPU 802, GPU 804, and/or DSP 806.

In some examples, wireless connectivity component 812 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 812 is further coupled to one or more antennas 814.

Processing system 800 may also include one or more sensor processing units 816 associated with any manner of sensor, one or more image signal processors (ISPs) 818 associated with any manner of image sensor, and/or a navigation component 820, which may include satellite-based positioning system components (e.g., GPS or GLONASS) as well as inertial positioning system components.

Processing system 800 may also include one or more input and/or output devices 822, such as screens, touch-sensitive surfaces (including touch-sensitive displays), physical buttons, speakers, microphones, and the like.

In some examples, one or more of the processors of processing system 800 may be based on an ARM or RISC-V instruction set.

Processing system 800 also includes memory 824, which is representative of one or more static and/or dynamic memories, such as a dynamic random access memory, a flash-based static memory, and the like. In this example, memory 824 includes computer-executable components, which may be executed by one or more of the aforementioned processors of processing system 800.

In particular, in this example, memory 824 includes a training component 824A and an inferencing component 824B. Though depicted as discrete components for conceptual clarity in FIG. 8, the illustrated components (and others not depicted) may be collectively or individually implemented in various aspects. Additionally, though depicted as residing on the same processing system 800, in some aspects, training and inferencing may be performed on separate systems.

In the illustrated example, the memory 824 further includes model parameters 824C and model hyperparameters 824D. The model parameters 824C may generally correspond to the learnable or trainable parameters of one or more machine learning models, such as emission and/or transition probabilities, as discussed above. In some aspects, the model parameters 824C may further include parameters such as for an embedded machine learning model (e.g., machine learning model 215 of FIG. 2), an appended machine learning model (e.g., machine learning model 315 of FIG. 3), a model used to generate dynamic parameters (e.g., machine learning model 415 of FIG. 4), and/or for a multi-branch architecture (e.g., machine learning models 515A and 515B of FIG. 5). In some aspects, the model hyperparameters 824D can generally include any additional values used, such as manually curated values for γ, α, β, and/or ζ in Equations 1, 2, and 3.

Though depicted as residing in memory 824 for conceptual clarity, in some aspects, some or all of the model parameters 824C and model hyperparameters 824D may reside in any other suitable location.

Processing system 800 further comprises training circuit 826 and inferencing circuit 827. The depicted circuits, and others not depicted, may be configured to perform various aspects of the techniques described herein.

In some aspects, training component 824A and training circuit 826 may generally be used to train or learn one or more parameters (e.g., model parameters 824C), as discussed above. Inferencing component 824B and inferencing circuit 827 may generally be used to generate inferences or predictions based on one or more learned parameters (e.g., model parameters 824C) and/or hyperparameters (e.g., model hyperparameters 823D), as discussed above.

Though depicted as separate components and circuits for clarity in FIG. 8, training circuit 826 and inferencing circuit 827 may collectively or individually be implemented in other processing devices of processing system 800, such as within CPU 802, GPU 804, DSP 806, NPU 808, and the like.

Generally, processing system 800 and/or components thereof may be configured to perform the methods described herein.

Notably, in other aspects, aspects of processing system 800 may be omitted, such as where processing system 800 is a server computer or the like. For example, multimedia processing unit 810, wireless connectivity component 812, sensor processing units 816, ISPs 818, and/or navigation component 820 may be omitted in other aspects. Further, aspects of processing system 800 may be distributed between multiple devices.

### Example Clauses

Implementation examples are described in the following numbered clauses:

Clause 1: A method, comprising: accessing a sequence of observations; accessing a hidden Markov model (HMM) comprising a set of transition probabilities, a set of emission probabilities, a transition coefficient hyperparameter, and an emission coefficient hyperparameter; and generating a first output inference from the HMM based on the sequence of observations.

Clause 2: A method according to Clause 1, wherein the HMM further comprises a linear hyperparameter.

Clause 3: A method according to Clause 1 or 2, wherein the transition coefficient hyperparameter and the emission coefficient hyperparameter were learned based on training data while training the HMM.

Clause 4: A method according to any of Clauses 1-3, further comprising refining the transition coefficient hyperparameter and the emission coefficient hyperparameter using continual learning based on the first output inference.

Clause 5: A method according to any of Clauses 1-4, further comprising generating the transition coefficient hyperparameter and the emission coefficient hyperparameter based on one or more observations of the sequence of observations.

Clause 6: A method according to any of Clauses 1-5, wherein generating the transition coefficient hyperparameter and the emission coefficient hyperparameter comprises processing the one or more observations of the sequence of observations using a neural network.

Clause 7: A method according to any of Clauses 1-6, wherein the HMM further comprises at least one of: a cross-correlation hyperparameter, a quadratic hyperparameter, or a nonlinear hyperparameter.

Clause 8: A method according to any of Clauses 1-7, wherein: at least one output inference from the HMM is generated using one or more transition probabilities and one or more emission probabilities, and at least one output inference from the HMM is generated using a neural network classifier that does not use the set of transition probabilities and the set of emission probabilities.

Clause 9: A method according to any of Clauses 1-8, further comprising generating an output inference, wherein generating the output inference includes processing the first output inference of the HMM using a neural network.

Clause 10: A method according to any of Clauses 1-9, further comprising: generating a second output inference, wherein generating the second output inference includes processing the sequence of observations using a recurrent neural network (RNN); and generating an overall output inference, wherein generating the overall output inference includes processing the first and second output inferences using a multilayer perceptron (MLP).

Clause 11: A processing system comprising: a memory comprising computer-executable instructions; and one or more processors configured to execute the computer-executable instructions and cause the processing system to perform a method in accordance with any of Clauses 1-10.

Clause 12: A processing system comprising means for performing a method in accordance with any of Clauses 1-10.

Clause 13: A non-transitory computer-readable medium comprising computer-executable instructions that, when executed by one or more processors of a processing system, cause the processing system to perform a method in accordance with any of Clauses 1-10.

Clause 14: A computer program product embodied on a computer-readable storage medium comprising code for performing a method in accordance with any of Clauses 1-10.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor-implemented method, comprising:
accessing a sequence of observations;
accessing a hidden Markov model (HMM) comprising a set of transition probabilities, a set of emission probabilities, a transition coefficient hyperparameter, and an emission coefficient hyperparameter; and
generating a first output inference from the HMM based on the sequence of observations.

2. The processor-implemented method of claim 1, wherein the HMM further comprises a linear hyperparameter.

3. The processor-implemented method of claim 1, wherein the transition coefficient hyperparameter and the emission coefficient hyperparameter were learned based on training data while training the HMM.

4. The processor-implemented method of claim 1, further comprising refining the transition coefficient hyperparameter and the emission coefficient hyperparameter using continual learning based on the first output inference.

5. The processor-implemented method of claim 1, further comprising generating the transition coefficient hyperparameter and the emission coefficient hyperparameter based on one or more observations of the sequence of observations.

6. The processor-implemented method of claim 5, wherein generating the transition coefficient hyperparameter and the emission coefficient hyperparameter comprises processing the one or more observations of the sequence of observations using a neural network.

7. The processor-implemented method of claim 1, wherein the HMM further comprises at least one of:
a cross-correlation hyperparameter,
a quadratic hyperparameter, or
a nonlinear hyperparameter.

8. The processor-implemented method of claim 1, wherein:
at least one output inference from the HMM is generated using one or more transition probabilities and one or more emission probabilities, and
at least one output inference from the HMM is generated using a neural network classifier that does not use the set of transition probabilities and the set of emission probabilities.

9. The processor-implemented method of claim 1, further comprising generating an output inference, wherein generating the output inference includes processing the first output inference of the HMM using a neural network.

10. The processor-implemented method of claim 1, further comprising:
generating a second output inference, wherein generating the second output inference includes processing the sequence of observations using a recurrent neural network (RNN); and
generating an overall output inference, wherein generating the overall output inference includes processing the first and second output inferences using a multilayer perceptron (MLP).

11. A processing system comprising:
a memory comprising computer-executable instructions; and
one or more processors configured to execute the computer-executable instructions and cause the processing system to perform an operation comprising:
accessing a sequence of observations;
accessing a hidden Markov model (HMM) comprising a set of transition probabilities, a set of emission probabilities, a transition coefficient hyperparameter, and an emission coefficient hyperparameter; and
generating a first output inference from the HMM based on the sequence of observations.

12. The processing system of claim 11, wherein the HMM further comprises a linear hyperparameter.

13. The processing system of claim 11, wherein the transition coefficient hyperparameter and the emission coefficient hyperparameter were learned based on training data while training the HMM.

14. The processing system of claim 11, the operation further comprising refining the transition coefficient hyperparameter and the emission coefficient hyperparameter using continual learning based on the first output inference.

15. The processing system of claim 11, the operation further comprising generating the transition coefficient hyperparameter and the emission coefficient hyperparameter based on one or more observations of the sequence of observations.

16. The processing system of claim 15, wherein generating the transition coefficient hyperparameter and the emission coefficient hyperparameter comprises processing the one or more observations of the sequence of observations using a neural network.

17. The processing system of claim 11, wherein the HMM further comprises at least one of:
a cross-correlation hyperparameter,
a quadratic hyperparameter, or
a nonlinear hyperparameter.

18. The processing system of claim 11, wherein:
at least one output inference from the HMM is generated using one or more transition probabilities and one or more emission probabilities, and
at least one output inference from the HMM is generated using a neural network classifier that does not use the set of transition probabilities and the set of emission probabilities.

19. The processing system of claim 11, the operation further comprising generating an output inference, wherein generating the output inference includes processing the first output inference of the HMM using a neural network.

20. The processing system of claim 11, the operation further comprising:
generating a second output inference, wherein generating the second output inference includes processing the sequence of observations using a recurrent neural network (RNN); and
generating an overall output inference, wherein generating the overall output inference includes processing the first and second output inferences using a multilayer perceptron (MLP).

21. A non-transitory computer-readable medium comprising computer-executable instructions that, when executed by one or more processors of a processing system, cause the processing system to perform an operation comprising:
accessing a sequence of observations;
accessing a hidden Markov model (HMM) comprising a set of transition probabilities, a set of emission probabilities, a transition coefficient hyperparameter, and an emission coefficient hyperparameter; and
generating a first output inference from the HMM based on the sequence of observations.

22. The non-transitory computer-readable medium of claim 21, wherein the HMM further comprises a linear hyperparameter.

23. The non-transitory computer-readable medium of claim 21, wherein the transition coefficient hyperparameter and the emission coefficient hyperparameter were learned based on training data while training the HMM.

24. The non-transitory computer-readable medium of claim 21, further comprising refining the transition coefficient hyperparameter and the emission coefficient hyperparameter using continual learning based on the first output inference.

25. The non-transitory computer-readable medium of claim 21, the operation further comprising generating the transition coefficient hyperparameter and the emission coefficient hyperparameter based on one or more observations of the sequence of observations.

26. The non-transitory computer-readable medium of claim 21, wherein the HMM further comprises at least one of:
a cross-correlation hyperparameter,
a quadratic hyperparameter, or
a nonlinear hyperparameter.

27. The non-transitory computer-readable medium of claim 21, wherein:
at least one output inference from the HMM is generated using one or more transition probabilities and one or more emission probabilities, and
at least one output inference from the HMM is generated using a neural network classifier that does not use the set of transition probabilities and the set of emission probabilities.

28. The non-transitory computer-readable medium of claim 21, the operation further comprising generating an output inference, wherein generating the output inference includes processing the first output inference of the HMM using a neural network.

29. The non-transitory computer-readable medium of claim 21, the operation further comprising:
generating a second output inference, wherein generating the second output inference includes processing the sequence of observations using a recurrent neural network (RNN); and
generating an overall output inference, wherein generating the overall output inference includes processing the first and second output inferences using a multilayer perceptron (MLP).

30. A processing system, comprising:
means for accessing a sequence of observations;
means for accessing a hidden Markov model (HMM) comprising a set of transition probabilities, a set of emission probabilities, a transition coefficient hyperparameter, and an emission coefficient hyperparameter; and
means for generating a first output inference from the HMM based on the sequence of observations.
